(19) United States
(12) Patent Application Publication
(10) Pub. No.: US 2013/0041566 A1
(43) Pub. Date: Feb. 14, 2013

(54) METHOD FOR CONTROLLING A WHEELED VEHICLE

(71) Applicant: Marc Gagnon, Austin (CA)

(72) Inventor: Marc Gagnon, Austin (CA)

(73) Assignee: BOMBARDIER RECREATIONAL PRODUCTS INC., Valcourt, QC (CA)

(21) Appl. No.: 13/643,368

(22) PCT Filed: Apr. 30, 2010
(86) PCT No.: PCT/US2010/033165

§ 371 Date: Oct. 25, 2012

(51) Int. Cl. F02D 29/02; F02D 9/02; F02D 13/00

(52) U.S. Cl. 701/70

(57) ABSTRACT

A method for controlling a vehicle having at least one driving wheel is disclosed. The method comprises operating the vehicle in a normal operation mode when at least one driving wheel is in contact with a ground on which the vehicle operates. The method further comprises operating the vehicle in a limit mode when a speed of the vehicle is above a first vehicle speed and an acceleration of the at least one driving wheel is above a first wheel acceleration. Operating the vehicle in the limit mode includes controlling an engine of the vehicle to at least reduce the 10 acceleration of the at least one driving wheel.

### FIELD OF THE INVENTION

The present invention relates to methods for controlling a wheeled vehicle.

### BACKGROUND OF THE INVENTION

All-terrain vehicles (ATV) are equipped with powerful engines to allow the driver to accelerate rapidly. When the vehicle is travelling at high speeds, the wheels of the vehicle, after going over an obstacle, can lose contact with the ground, and as a result the driving wheels accelerate due to the reduced load on the engine. When the vehicle lands back on the ground, the driving wheels are forced to decelerate from their current accelerated wheel speed to correspond to that of the actual vehicle speed in a very short period of time. This speed difference induces a forced sudden deceleration on the rotating parts (i.e. wheels, half-shafts, drive shaft, etc.) which creates stress forces in the drivetrain components. In situations where this speed difference is significant and when these stresses are repeated over time, the forces generated on the drivetrain can buckle, bend and/or break the drivetrain components.

To resist these forces and hence to avoid damaging the drivetrain, ATVs are equipped with drivetrain components typically bulkier to be more resistant than the ones found in other vehicles, such as vehicles for road use. Unfortunately, the bulkier components add cost and weight to the vehicle which can limit the performance characteristics of the ATV.

Therefore, there is a need for a system that would diminish the forces in the drivetrain components generated in situations such as landing.

There is also a need for such a system that would not add significant weight to the drivetrain components.

### SUMMARY OF THE INVENTION

It is an object of the present invention to ameliorate at least some of the inconveniences present in the prior art.

It is also an object of the present invention to provide a method for controlling a wheel speed when the wheels of the vehicle are off the ground. In one aspect the present invention provides a method for controlling a vehicle having wheels. The wheels include at least one driving wheel. The method comprising operating the vehicle in a normal operation mode, and operating the vehicle in a limit mode when a speed of the vehicle is above a first vehicle speed and an acceleration of the at least one driving wheel is above a first wheel acceleration. Operating the vehicle in the limit mode includes controlling an engine of the vehicle to at least reduce the acceleration of the at least one driving wheel.

In an additional aspect, in the normal operation mode at least one of the at least one driving wheel is in contact with a ground on which the vehicle operates, and in the limit mode all the wheels are not in contact with the ground.

In a further aspect, the vehicle is operated in the limit mode when the acceleration of the at least one driving wheel is above the first wheel acceleration for a first period of time.

In an additional aspect, the vehicle is operated in the limit mode when the speed of the vehicle is above the first vehicle speed for a second period of time.

In a further aspect, the method further comprises returning to operating the vehicle in the normal operation mode when an interruption event occurs during the operation of the vehicle in the limit mode. The interruption event is at least one of the acceleration of the at least one driving wheel being at or below a second wheel acceleration, a speed of the at least one driving wheel being at or below a first wheel speed, a speed of the engine being at or below a first engine speed, brakes of the vehicle being applied, a position of a throttle lever of the vehicle being changed, and a control time having elapsed.

In an additional aspect, the control time is between 0 and 100 ms.

In a further aspect, the second wheel acceleration is smaller than the first wheel acceleration.

In an additional aspect, the second wheel acceleration is about zero.

In a further aspect, the method further comprises sensing a temperature of an environment. The vehicle is operated in the limit mode only when the temperature of the environment is above a predetermined temperature.

In an additional aspect, the first wheel acceleration is a function of the speed of the vehicle.

In a further aspect, the first wheel acceleration is greater than a maximum acceleration of the at least one driving wheel when the at least one driving wheel is in contact with a ground on which the vehicle operates.

In an additional aspect, operating the vehicle in the limit mode includes controlling the engine to eliminate the acceleration of the at least one driving wheel.

In a further aspect, controlling the engine to at least reduce the acceleration of the at least one driving wheel includes at least one of reducing an ignition timing of the engine, reducing an amount of fuel delivered to the engine, and reducing an amount of air flow delivered to the engine.

In another aspect, the invention provides a method for controlling a vehicle having wheels. The wheels include at least one driving wheel. The method comprises operating the vehicle in a normal operation mode, and operating the vehicle in a limit mode when all the wheels are not in contact with the ground a ground on which the vehicle operates. In the limit mode a rotation of the at least one driving wheel is controlled without active input of a driver of the vehicle.

In an additional aspect, the vehicle is operated in the limit mode when all the wheels are not in contact with the ground for a period of time.

In a further aspect, the method further comprises determining via a sensor linked to a suspension system of the vehicle that all the wheels of the vehicle are not contact with the ground.

In an additional aspect, the rotation of the at least one driving wheel is controlled by an Electronic Control Unit.

In a further aspect, operating the vehicle in the limit mode includes at least reducing a difference between a speed of the vehicle based on a rotational speed of the at least one driving wheel and an actual speed of the vehicle.

In an additional aspect, at least reducing the difference between the speed of the vehicle based on a rotational speed of the at least one driving wheel and the actual speed of the vehicle includes at least reducing an acceleration of the at least one driving wheel.

In a further aspect, at least reducing the difference between the speed of the vehicle based on a rotational speed of the at least one driving wheel and the actual speed of the vehicle includes controlling an engine torque output of an engine of the vehicle.

For the purpose of this application, terms related to spatial directions such as ‘front’, ‘rear’, ‘forward’, ‘rearward’, ‘left’, ‘right’ are defined with respect to a forward direction of travel of the vehicle, and should be understood as they would be understood by a rider sitting on the ATV in a normal riding position.

The term ‘vehicle speed’ refers to a speed computed from a rotational speed of a driving wheel of a vehicle having at least one driving wheel. The term ‘actual vehicle speed’ refers to an actual speed of the vehicle independently from a rotational speed of the at least one driving wheel of the vehicle.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1A is a perspective view, taken from a front, left side, of an all-terrain vehicle (ATV) operating on the ground;

FIG. 1B is a left side elevation view of the ATV of FIG. 1A with all wheels off the ground after going over an obstacle at high speeds;

FIG. 2 is a schematic layout of a drivetrain of the ATV of FIG. 1A;

FIG. 3 is a side elevation view of an engine and a transmission of the ATV of FIG. 1A;

FIG. 4 is a schematic side view of a portion of the drivetrain of FIG. 2 with an arrow indicating a direction of rotation of a driveshaft;

FIG. 5 is a schematic illustration of a system for controlling the driving wheels of the ATV of FIG. 1A according to an example embodiment of the invention;

FIG. 6 is a flow chart of a method for controlling the driving wheels of the ATV of FIG. 1A, according to a first embodiment of the invention;

FIG. 7 is a flow chart of a method for controlling the driving wheels of the ATV of FIG. 1A, according to a second embodiment of the invention;

FIG. 8 is a graph of predetermined wheel accelerations with respect to vehicle speeds;

FIG. 9 is a graph of the velocity change over time of the vehicle speed controlled by the method of FIG. 6, the actual vehicle speed and the vehicle speed not controlled by the method of FIG. 6; and

FIG. 10 is a graph of the velocity change over time of the vehicle speed controlled by the method of FIG. 7, the actual vehicle speed and the vehicle speed not controlled by the method of FIG. 7.

### DETAILED DESCRIPTION OF THE PREFERRED EMBODIMENTS

The present invention is being described throughout this description as being used in a four-wheeled all-terrain vehicle (ATV); however it is contemplated that the invention could be used in other wheeled vehicles having at least one driving wheel, such as side-by-side off-road vehicles, sometimes referred to as the UTVs, three-wheel vehicles, and snowmobiles.

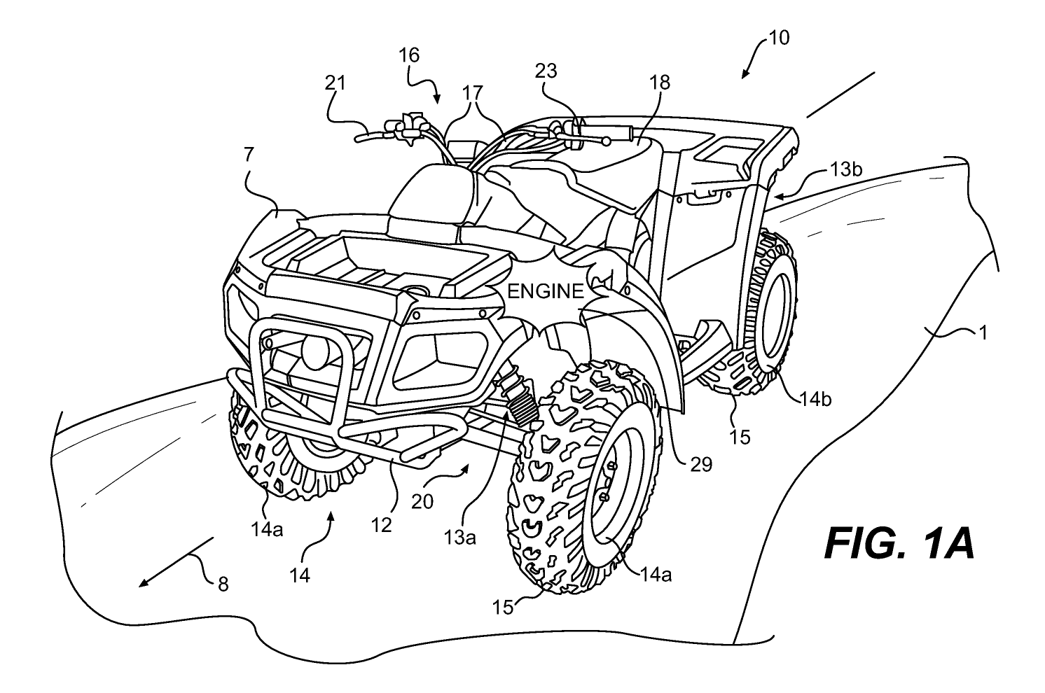

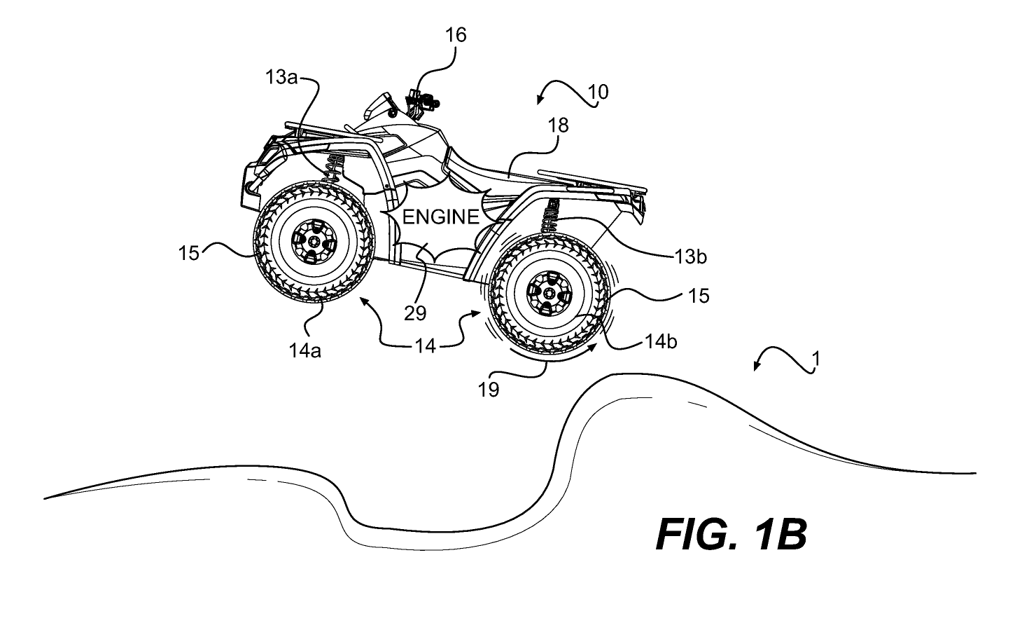

FIG. 1A is a perspective view of an ATV 10 operating on a ground 1 and FIG. 1B is a perspective view of the ATV 10 performing a jump over the ground 1. The ATV 10 includes a frame 12 to which is mounted a body 13 and an internal combustion engine 29 (schematically shown in FIGS. 1A and 1B) for powering the vehicle. It is contemplated that the body 13 could be formed of multiple body portions. Also connected to the frame 12 are the wheels 14 including two front wheels 14a and two rear wheels 14b. All four wheels 14 are with low-pressure balloon tires 15 which are adapted for off-road conditions and traversing rugged terrain. The ATV 10 further includes a straddle seat 18 mounted to the frame 12 for supporting a driver and optionally one or more passengers. The ATV 10 has a center of gravity through which traverses a central longitudinal axis 8.

The ATV 10 further includes a steering mechanism 16 which is rotationally supported by the frame 12 to enable a driver to steer the vehicle. The steering mechanism 16 includes handlebars 17 connected to a steering column (not shown) for actuating steering linkages connected to left and right front drive assemblies.

The two front wheels 14a are suspended from the frame 12 by respective front suspension assemblies 13a (e.g. double A-arm suspension systems), and the two rear wheels 14b are suspended from the frame 12 by respective rear suspension assemblies 13b (e.g. single or double swing arm suspension systems). The front and rear wheels 14a, 14b are each disposed with a low-pressure balloon tire 15.

The engine 29 is a V-type internal combustion engine. As will be readily appreciated by those of ordinary skill in the art, other types and configurations of engines can be substituted. The cylinders house reciprocating pistons 31 connected to a crankshaft 34, as is also well known in the art. The crankshaft 34 of the engine 29 is coupled to a drivetrain 20 which delivers torque to at least one of the wheels 14, providing at least one-wheel-drive (1WD). The drivetrain 20 can also selectively delivers torque to one or more of the wheels 14 (driving wheels 11b) to provide one-wheel-drive (1WD), two-wheel-drive (2WD), three-wheel-drive (3WD) or four-wheel-drive (4WD), as it will be explained below.

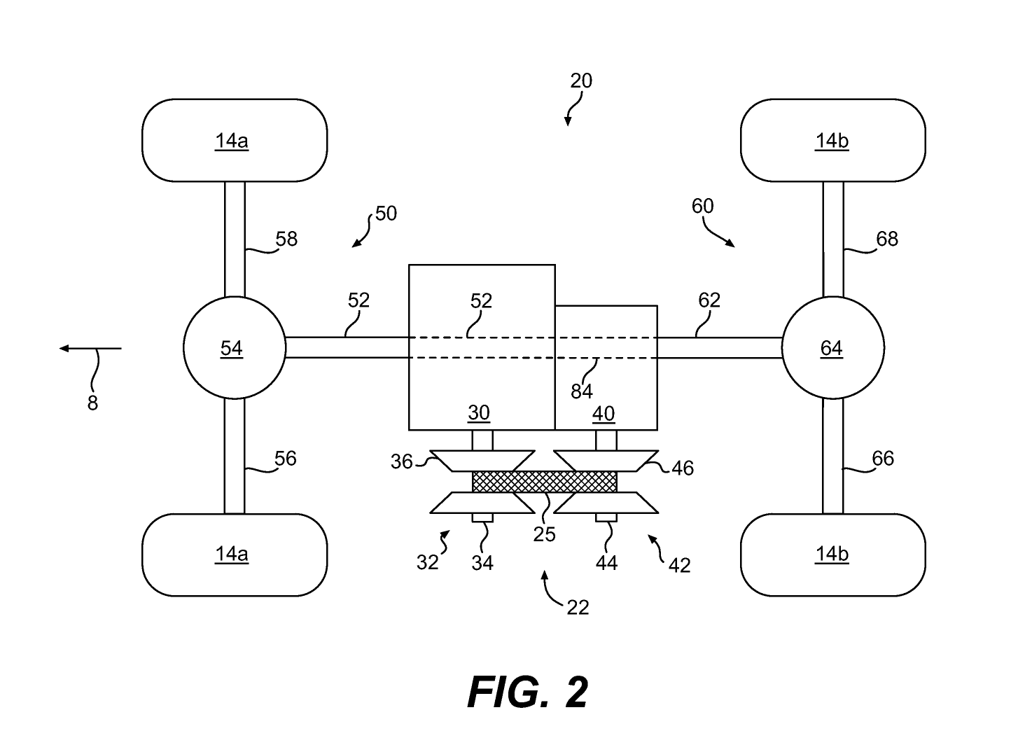

FIG. 2 illustrates schematically the layout and power pack of the drivetrain 20. The drivetrain 20 includes a distinct transmission 40 that is detachably connected to a rear portion of the engine casing 30. The transmission 40 is preferably connected to the engine casing 30 with threaded fasteners 70, e.g. bolts, which facilitate assembly and disassembly of the transmission 40.

The engine 29 and transmission 40 are operatively connected by a continuously variable transmission (CVT) 22 having a belt 25 connecting an engine output 32 to a transmission input 42. The engine output 32 includes a crankshaft 34 connected to and driven by the pistons 31 in the cylinders of the internal combustion engine. Mounted to the crankshaft 34 is a drive pulley 36 which drives a corresponding driven pulley 46 via the belt 25. The driven pulley 46 is mounted to an input shaft 44 which delivers power to the transmission 40. The transmission 40 has a gearbox (not shown, but well known in the art) to reduce the angular velocity of the input shaft 44 in favor of greater torque.

The transmission 40 operatively connects to both a front drive system 50 and a rear drive system 60. The front drive system 50 includes a front drive shaft 52 connected at a rearward end to the transmission 40 (i.e. to a forward end of an intermediary shaft 84 of the transmission 40) and at a forward end to a front differential 54. The front differential 54 is connected to a left front axle 56 and a right front axle 58 which are, in turn, connected to the front wheels 14a. Likewise, the rear drive system 60 includes a rear drive shaft 62 connected at a forward end to the transmission 40 (i.e. to a rearward end of the intermediary shaft 84 of the transmission 40) and at a rearward end to a rear differential 64. The rear differential 64 connects to a left rear axle 66 and a right rear axle 68 which are, in turn, connected to the rear wheels 14b (left and right respectively). Therefore, the drivetrain 20 allows the driver to select either 1WD, 2WD, 3WD or 4WD.

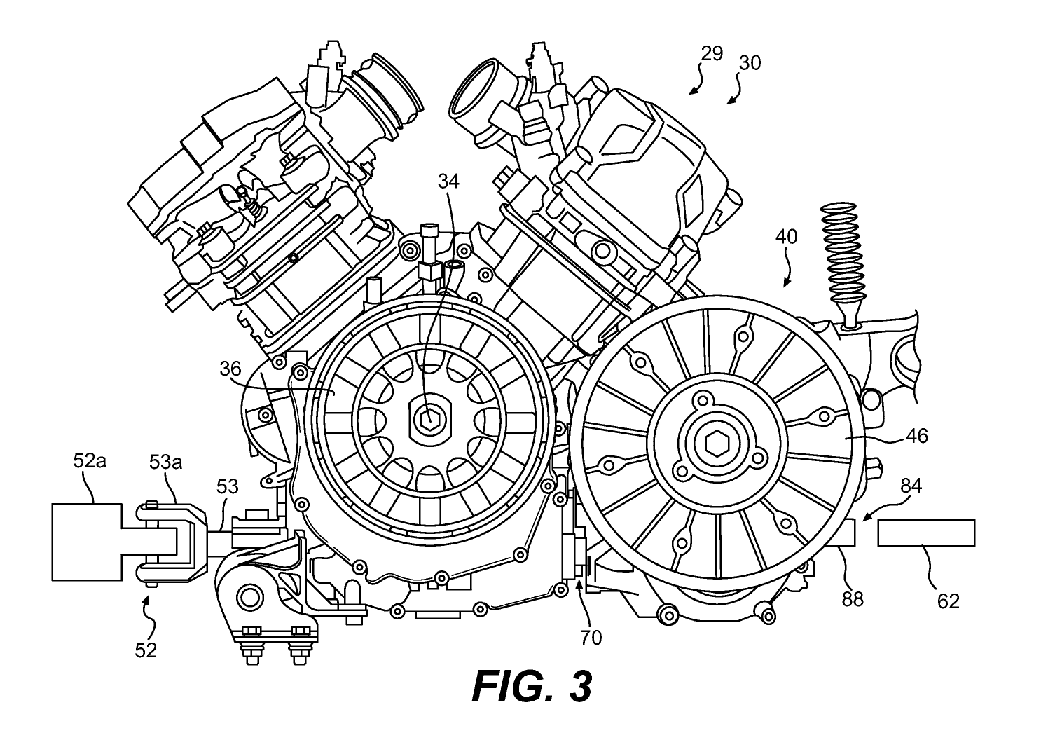

As shown in FIG. 3, the intermediary shaft 84 has a splined rearward end 88 that protrudes from the rear of the transmission 40 to mesh with complementary splines on a front end of the rear drive shaft 62.

The first subshaft 53 of the front drive shaft 52 passes through the engine casing 30 and protrudes from a forward face of the engine casing 30 to terminate in a universal joint 53a. The universal joint 53a rotationally connects the first subshaft 53 and the second subshaft 52a of the front drive shaft 52. Alternatively, a single front drive shaft 52 could pass through the engine casing 30 to deliver torque from the transmission 40 to the front differential 54 and to the front wheels 14a. The front drive shaft 52 passes through a bottom portion of the engine casing 30, beneath the crankshaft 34 and above the oil pan 37, as will be described and illustrated below.

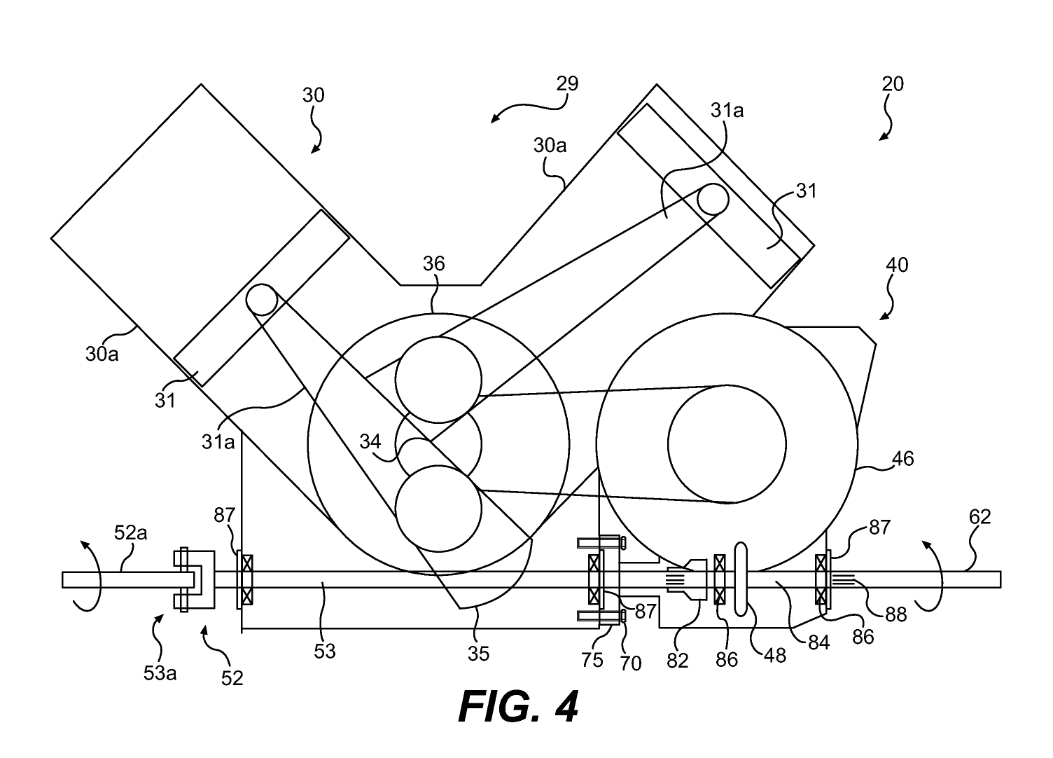

FIG. 4 is a schematic side view of a portion of the drivetrain 20 with arrow indicating a direction of rotation of the front drive shaft 52 and rear drive shaft 62. The internal combustion engine 29 is a V-type engine having a pair of cylinders 30a. Each cylinder 30a has a reciprocating piston 31 connected to a connecting rod (or piston rod) 31A for turning respective cranks on the common crankshaft 34 as is well known in the art of internal combustion engines. The crankshaft 34 has two pairs of downwardly depending counterweights 35. Finally, as mentioned above, the drive pulley 36 is mounted to the crankshaft 34 for driving the driven pulley 46 via the belt-driven CVT 22.

The transmission 40 includes a reduction gear 48 securely mounted to the intermediary shaft 84. The intermediary shaft 84 is supported by and runs on a plurality of bearings 86 housed in bearing mounts. A rearward end of the intermediary shaft 84 has splines 88 to mesh with complementary splines in the rear drive shaft 62.

A forward end of the intermediary shaft 84 also has splines which selectively mesh with a 2WD-4WD selector coupling, e.g. a splined sleeve 82 which is axially actuated to couple power to the first subshaft 53. The first subshaft 53 preferably passes through a bore in the mounting flange 75. The first subshaft 53 passes through the engine casing 30, passing between the counterweights 35. The first subshaft 53 terminates in the universal joint 53a for connecting to the second subshaft 52a.

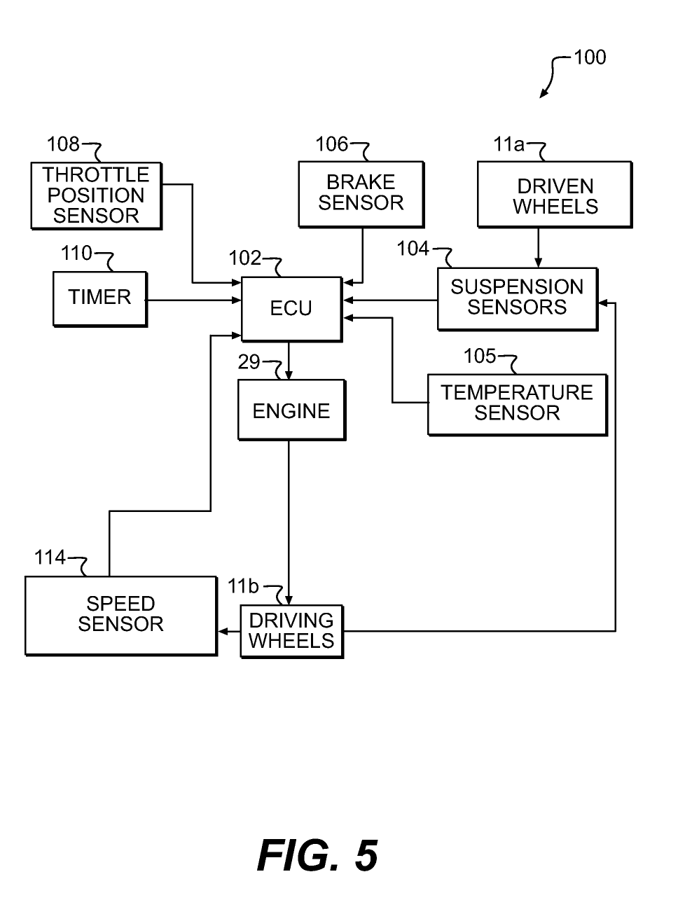

Turning to FIGS. 5-7, a system 100 and methods 200, 300 for controlling the driving wheels 11b (could be one or more depending if the ATV 10 is in 1 or more WD) of the ATV 10 will now be described. As seen in FIG. 5, the system 100 comprises an Electronic Control Unit (ECU) 102 electrically connected to the engine 29. The ECU 102 receives signals from various sensors located on the ATV 10. The ECU 102 receives signals from suspension sensors 104 located in the front suspensions 13a and the rear suspension 13b (left and right sensors for each of the front and rear suspensions 13a, 13b) associated with driven wheels 11a and the driving wheels 11b. The suspension sensors 104 provide the ECU 102 with information on the degree of compression of the suspensions 13a, 13b. The ECU 102 can determine if one or more wheels 14 are in contact with the ground 1, based on signals from the suspensions sensor 104. It is contemplated that the suspension sensors 104 could be omitted in some embodiments of the invention.

The ECU 102 also receives signals from a temperature sensor 105. The temperature sensor 105 is used to determine if a temperature of an environment in which the ATV 10 operates is in a range where ice could form on the ground 1, which could make the driving wheels 11b slip. It is contemplated that the temperature sensor 105 could be used for other purposes, such as to control the air/fuel mixture to the engine 29. It is also contemplated that other ways could be used to determine if one or more driving wheels 11b are slipping on the ground 1.

A brake sensor 106 is connected to the ECU 102. The brake sensor 106 provides the ECU 102 with information on a state of engagement of a brake lever 23 at the handlebars 17 of the ATV 10. It is contemplated that the brake sensor 106 could additionally indicate a degree of engagement of the brakes.

A throttle position sensor 108 is connected to the ECU 102. The throttle position sensor 108 determines a throttle position. The throttle position sensor 108 is associated with a throttle lever 21 on the handlebars 17 that is actuable by the driver. It is contemplated that the throttle position sensor 108 could be associated with a throttle body (not shown) connected to the engine 29. It is contemplated that the throttle position sensor 108 could be associated with any other component providing an indication of the throttle position.

A timer 110 is operatively connected to the ECU 102. The timer 110 is used in connection with the methods 200, 300 as will be described in greater detail below. It is contemplated that the timer 110 could be integrated in the ECU 102. It is also contemplated that the timer 110 could be omitted in the methods 200, 300.

The ECU 102 also connects to a speed sensor 114. The speed sensor 114 is a rotational sensor associated with one of the shafts of the transmission 40 from which a speed of rotation of the driving wheels 11b (V_{wheel}) can be computed. From the rotational speed V_{wheel} of the driving wheels 11b taken at different instants, the ECU 102 can determine a rotational acceleration a_{wheel} of the driving wheels 11b. From the instantaneous wheel speed V_{wheel}, the ECU 102 can also determine an instantaneous speed of the vehicle Vᵥₑₕ (Vᵥₑₕ=3πXD/50, where X is the engine 29 speed in revolution per minutes and D the diameter of the driving wheels 11b is meters and the vehicle speed Vᵥₑₕ is in km per hour).

When the ATV 10 is operating on the ground 1 and assuming no slipping of the driving wheels 11b, the vehicle speed Vᵥₑₕ deduced from information of the speed sensor 114 is an actual vehicle speed AVᵥₑₕ, i.e. it is the speed (or almost the speed) at which the ATV 10 is actually travelling across the ground. When the ATV 10 is in the air and the driving wheels 11b have lost contact with the ground 1, the vehicle speed Vᵥₑₕ is not the actual vehicle speed AVᵥₑₕ anymore. When in the air, the driving wheels' 11b rotation does not reflect the actual speed of the vehicle anymore. As illustrated in FIG. 1B by arrow 19, when the ATV 10 is not in contact with the ground 1, the driving wheels 11b accelerate and the vehicle speed Vᵥₑₕ exceeds the actual vehicle speed AVᵥₑₕ. When in the air, only the wheel speed V_{wheel} and acceleration a_{wheel} can be deducted from information provided by the speed sensor 114. When in the air, the speed sensor 114 does not provide information on the actual vehicle speed AVᵥₑₕ. It is contemplated that a vehicle speed sensor could be connected to the ECU 102 to determine the actual vehicle speed AVᵥₑₕ after the driving wheels 11b have lost contact with the ground 1. The speed sensor could be a Global Positioning System (GPS).

Based on information from at least some of the suspension sensors 104, the temperature sensor 105, the brake sensor 106, the throttle position sensor 108, the timer 110, and the speed sensor 114, the ECU 102 controls an operation of the engine 29 and therefore of the torque output of the engine 29 which acts directly on the driving wheels 11b. Control of the engine 29 by the ECU 102 will be described in greater details below with respect to the methods 200, 300.

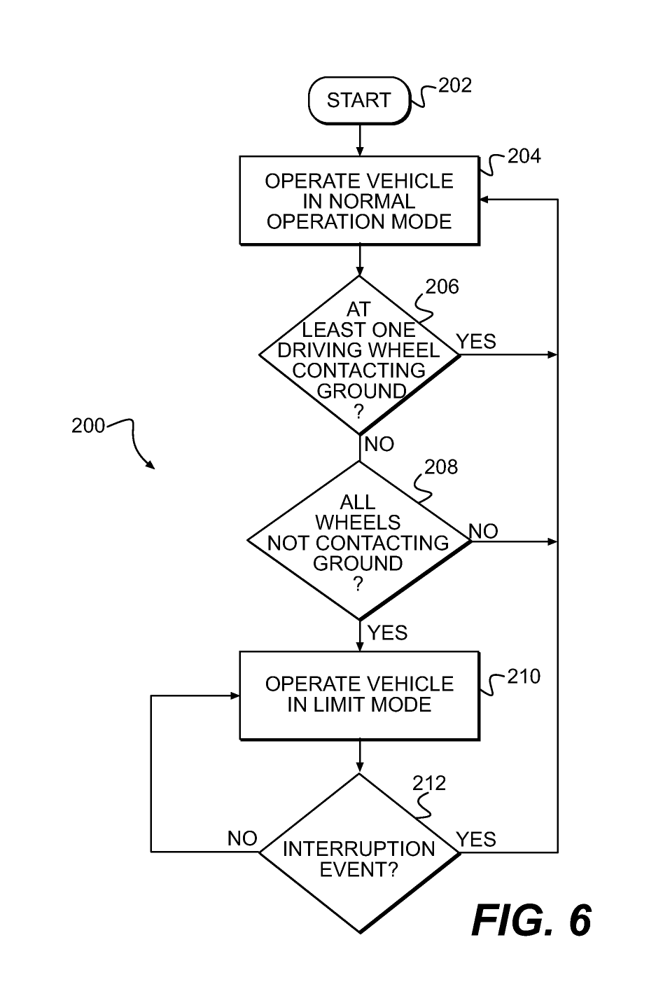

Referring now to FIG. 6, the method 200 of controlling the driving wheels 11b according to a first embodiment of the invention will be described.

The method 200 starts at step 202. At step 204, the ATV 10 is operated in a normal operation mode. In the normal operation mode, the driver actively controls the engine 29 via the throttle lever 21. In other words, in the normal operation mode, the wheel speed V_{wheel} (and as a consequence the wheel acceleration a_{wheel} an the vehicle speed Vᵥₑₕ) is controlled based on input of the driver. In the normal operation mode, the ATV 10 operates mostly on the ground 1.

At step 206, it is determined if at least one of the driving wheels 11b is in contact with the ground 1. It is contemplated that step 206 could be omitted. It is also contemplated that step 206 could be determining if at least one of the driving wheels 11b is not in contact with the ground 1 for a period of time. It is contemplated that the period of time could be predetermined or computed in real-time by the ECU 102 using the timer 110. Determination of whether at least one of the driving wheels 11b is in contact with the ground 1 is based on signals received from by the suspension sensors 104. If at least one of the driving wheels 11b is in contact with the ground 1, the method 200 returns to step 202 and the ATV 10 continues to operate in the normal operation mode. If, however, at least one driving wheel 11b is not in contact with the ground 1 the method 200 goes to step 208 to determine if all wheels 14 are not in contact with the ground 1 (such as after going over an obstacle shown in FIG. 1B). It is contemplated that step 208 could be determining if all wheels 14 are not in contact with the ground 1 for a period of time. It is contemplated that the period of time could be predetermined or computed in real-time by the ECU 102 using the timer 110.

At step 208, if all wheels 14 are not in contact with the ground 1, the ATV 10 is operated in a limit mode (step 210). The limit mode is a mode where the ECU 102 controls the engine 29 to control the wheel speed V_{wheel} of the driving wheels 11b without active input from the driver. As mentioned above, when the ATV 10 is not contacting the ground 1, the driving wheels 11b accelerate, and such accelerations lead to wheel speeds V_{wheel} that may damage the drivetrain 20 (instantaneously or over time) upon landing of the ATV 10 on the ground 1. The consequence of limiting the wheel speeds V_{wheel} in the limit mode is that a difference between the vehicle speed Vᵥₑₕ and the actual vehicle speed AVᵥₑₕ is limited, and forces generated in the drivetrain 20 upon landing are reduced compared to the ATV 10 where the wheel speed V_{wheel} is not controlled.

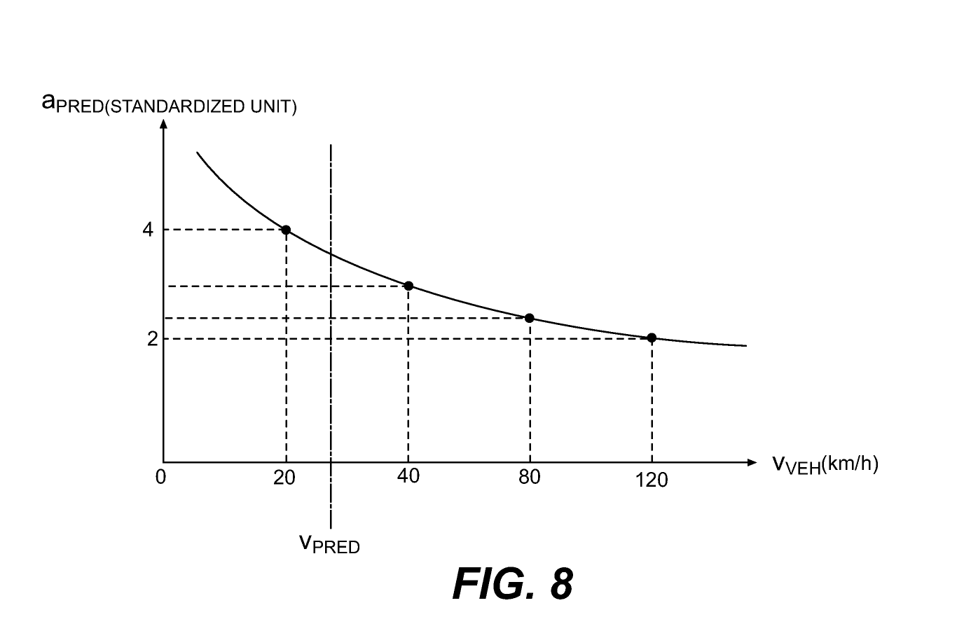

One way to limit the vehicle speed Vᵥₑₕ is to reduce the wheel acceleration a_{wheel} to a value that is below a_{pred}. a_{pred} is a predetermined value depending on the vehicle speed Vᵥₑₕ. FIG. 8 shows an example of values of a_{pred} as a function of the vehicle speed Vᵥₑₕ. a_{pred} is a wheel acceleration for which at that vehicle speed Vᵥₑₕ, the ATV 10 is most likely not being operated in contact with the ground 1.

To reduce the wheel acceleration a wheel, the ECU 102 controls the engine 29 to reduce a rotational acceleration of the subshafts 66, 68 that are linked to the driving wheels 11b. This is achieved by controlling an ignition timing of the engine 29. Alternatively (or in addition), an amount of fuel delivered to the engine 29, an amount of air flow delivered to the engine 29, or the transmission ratio of the CVT 22 could be controlled. Other ways to control the engine 29 output are contemplated.

It is preferred to use a Proportional Integral Derivative (PID) controller to reduce the wheel acceleration a_{wheel} in a controlled manner.

The ECU 102 is further programmed to exit the limit mode when an interruption event occurs (step 212). The interruption event is when the soonest of the acceleration a_{wheel} of the driving wheels 11b being at or below the line of predetermined wheel accelerations corresponding to the measured vehicle speed Vᵥₑₕ in FIG. 8, the wheel speed V_{wheel} being at or below a first wheel speed, a speed of the engine 29 being at or below a first engine speed, brakes being applied, a position of the throttle lever 21 being been changed, and a period of time having elapsed since the ATV 10 has started to be operated in the limit mode.

The second predetermined wheel acceleration could be anything under the line in FIG. 8 for a measured vehicle speed Vᵥₑₕ. The first wheel speed and/or first engine speed could be values corresponding to their respective values as computed by the ECU 102 just prior to determining that the limit mode should be activated. The period of time is given by the timer 110. The period of time is between 0 and 100 ms. Other period of times are contemplated. The period of time could be predetermined or computed in real-time by the ECU 102 using the timer 110.

It is contemplated that the interruption event could be the suspension sensors 114 indicate that at least one driving wheel 11b is in contact with the ground 1. It is contemplated that the interruption event could alternatively be the at least one driving wheel 11b is in contact with the ground 1 for a period of time. It is contemplated that the interruption event could be a combination of more than one of the above listed interruption events.

If at step 212, the interruption event occurs, the method 200 goes back to step 202, where the ATV 10 is operated in the normal mode, and if the interruption event does not occur, the method 200 goes back to step 210, where the ATV 10 is operated in the limit mode.

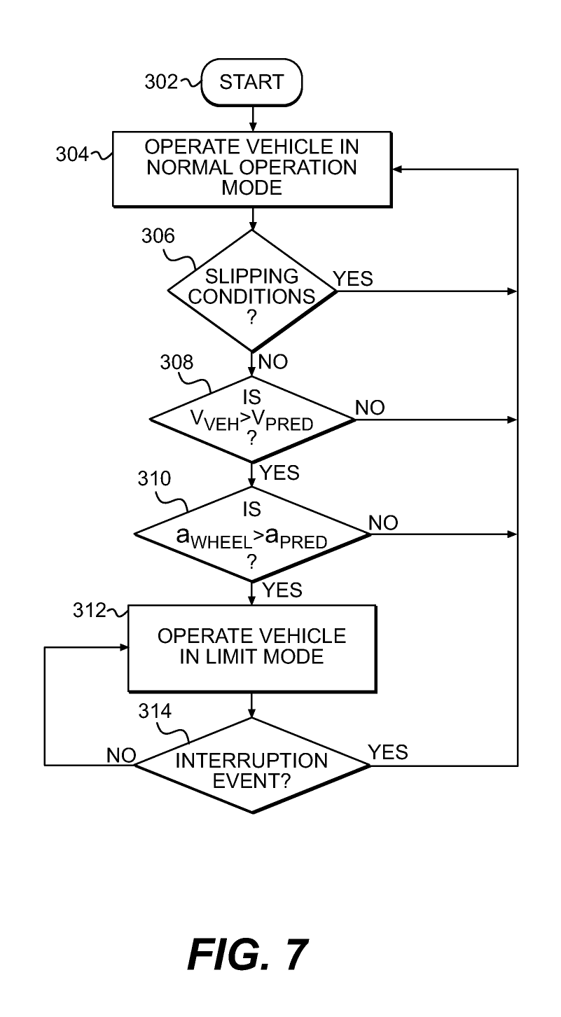

Referring now to FIG. 7, the method 300 for controlling the driving wheel 11b of the ATV 10 according to a second embodiment will be described.

The method 300 starts at step 302. At step 304, the ATV 10 is operated in the normal operation mode. The normal operation mode is the mode where the driver is actively controlling the engine 29 via the throttle lever 21 that has been described above with respect to step 204.

At step 306, the method 300 determines if conditions are prone to wheel slip. To determine if conditions are prone to wheel slip, the ECU 102 processes information from the temperature sensor 105. If a temperature of the environment is below a predetermined temperature, it is determined that conditions are prone to slip.

In the present embodiment, the predetermined temperature is zero degrees Celsius (0° C.). It is contemplated that the predetermined temperature could be programmed to be another value or to be fluctuating depending on other parameter (e.g. humidity rate, atmospheric pressure).

If the conditions are not prone to wheel slip at step 306, it is determined at step 308 if the vehicle speed Vᵥₑₕ is greater than a predetermined vehicle speed V_{pred}. The predetermined vehicle speed V_{pred} is between 0 and 50 km per hour. Other predetermined vehicle speeds V^{pred} are contemplated. It is contemplated that the predetermined vehicle speed V_{pred} could be computed in real-time by the ECU 102. It is alternatively contemplated that step 308 could determine if the vehicle speed Vᵥₑₕ is greater than a predetermined vehicle wheel speed V_{pred} for period of time. It is contemplated that the period of time could be predetermined or computed in real-time by the ECU 102 using the timer 110. The predetermined vehicle speed V_{pred} is a lower bound speed below which the drivetrain 20 is unlikely to be damaged upon landing. It is also contemplated that step 308 could alternatively determine if the wheel speed V_{wheel} is greater than a first predetermined wheel speed. The first predetermined wheel speed is a lower bound of the wheel speed V_{wheel} below which the ATV 10 does not need to be operated in the limit mode.

At step 308, if the vehicle speed Vᵥₑₕ is lower than the predetermined vehicle speed V_{pred}, the method 300 goes back to step 304 and continues to operate the ATV 10 in the normal operation mode, and if the vehicle speed Vᵥₑₕ is above the predetermined vehicle speed V_{pred}, the method 300 goes to step 310.

At step 310, it is determined whether the wheel acceleration a_{wheel} of the driving wheels 11b is greater than a first predetermined acceleration a_{pred}. As explained above, the wheel acceleration a_{wheel} is computed by taking several readings of the instantaneous vehicle speed Vᵥₑₕ at different time intervals. Although only two readings are necessary, it is preferred to conduct several of them in order to determine that the increase in wheel acceleration corresponds to a situation where the ATV 10 is going over an obstacle and has all wheels 14 in the air, and therefore to avoid premature initiation of the limit mode. Indeed, vehicles such as the ATV 10 are often operated on a loose rough terrain which could allow the wheels 14 to momentarily loose contact with the ground 1 and produce sudden increase in wheel acceleration a_{wheel} and wheel speed V_{wheel} for which impact upon landing would not damage the drivetrain 20 components and for which it is not desired to activate the limit mode.

It is contemplated that the first predetermined acceleration a_{pred} could be computed in real-time by the ECU 102. The first predetermined wheel acceleration a_{pred} is an upper bound of the wheel acceleration a_{wheel} corresponding to a limit above which it is desired to limit the wheel speed V_{wheel} in order to at least reduce potential damage to in the drivetrain 20 upon landing of the ATV 10. It is desired to enter the limit mode when the driving wheels 11b have reached a wheel accelerations a_{wheel} that indicates that the driving wheels 11b have lost contact with the ground 1. The first predetermined wheel acceleration a_{pred} is at or above a maximum possible wheel acceleration experienced when at least one driving wheel 11b is in contact with the ground 1. The first predetermined wheel acceleration a_{pred} depends on the vehicle speed Vᵥₑₕ. For a given vehicle speed Vᵥₑₕ, the ECU 102 refers to a predetermined map of wheel accelerations a_{wheel} with respect to vehicle speeds Vᵥₑₕ (an example of which is shown in FIG. 8) to determine the predetermined wheel acceleration a_{pred}. It is contemplated that the ECU 102 could compute a value of the first predetermined erm ned wheel acceleration a_{pred} in real-time.

It is contemplated that step 310 could be determining if the wheel acceleration a_{wheel} is greater than the first predetermined wheel acceleration a_{pred} for a period of time. For example, the period of time could be 1 second. It iscontemplated that the period of time could be computed in real time by the ECU 102 using the timer 110 or be pre-programmed. It is contemplated that the period of time for the vehicle speed Vᵥₑₕ at step 308 and for the wheel acceleration a_{wheel} at step 310 could have a same value.

At step 310, if the wheel acceleration a_{wheel} the driving wheels 11b is above the first predetermined wheel acceleration aₚₙₑ, of the method 300 goes to step 312 where the ATV 10 is operated in the limit mode, and if the wheel acceleration a_{wheel} of the driving wheels 11b is below the first predetermined wheel acceleration a_{pred}, the method 300 goes back to step 304 where the ATV 10 continues to be operated in the normal operation mode.

At step 312, the ATV 10 is operated in the limit mode. The limit mode is a mode where the engine 29 is controlled by the ECU 102 to control the wheel speed V_{wheel}, as described in step 210 with respect to the method 200. Step 312 being similar to step 210, it will not be repeated.

From step 312, the method goes to step 314. At step 314, the limit mode is exited if an interruption event occurs. The interruption event is the soonest of the interruption events described above with respect to 212. Alternative embodiments described at step 212 are also contemplated. Step 314 being similar to step 212, it will not be repeated.

At step 314, if the interruption event occurs, the method 300 returns to step 304 wherein the ATV 10 is operated in the normal operation mode, and if the interruption event does not occur, the method 300 returns to step 312 wherein the ATV 10 is operated in the limit mode.

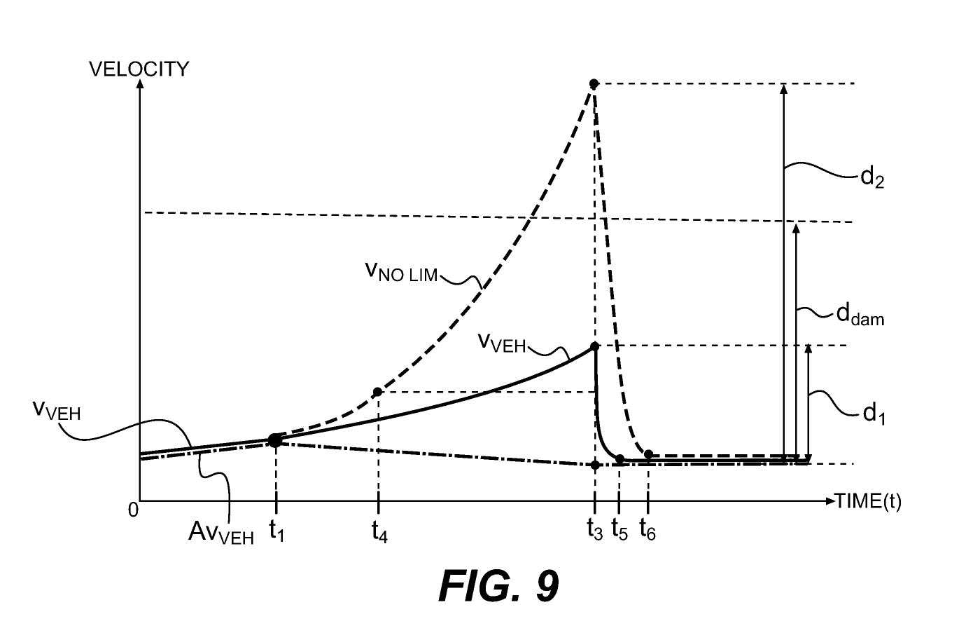

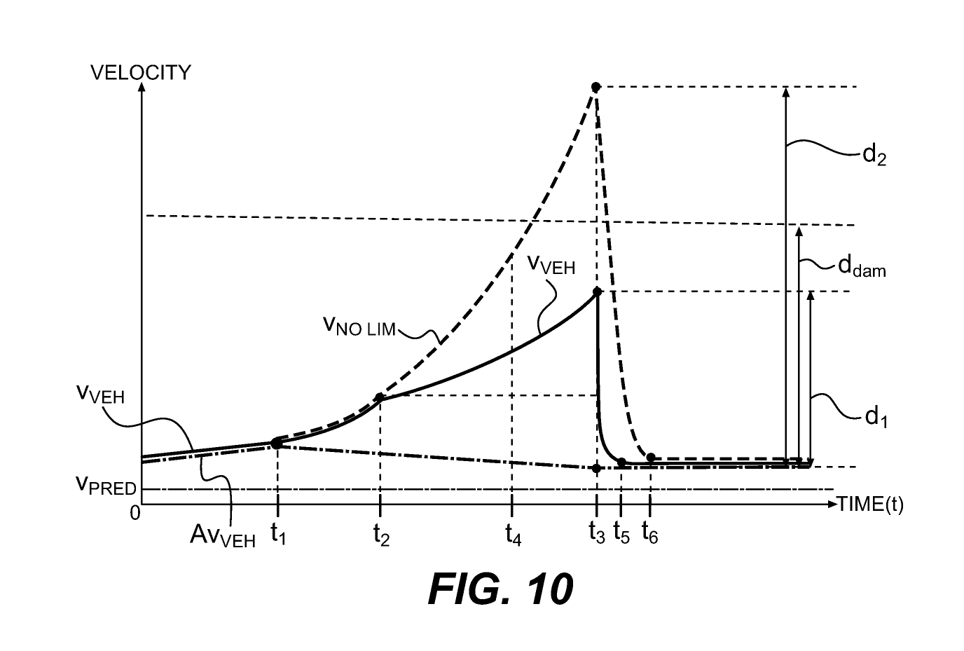

FIGS. 9 and 10 are graphs showing each an example of an evolution of the vehicle speed Vᵥₑₕ over time when the ATV 10 is above the ground 1 after going over an obstacle, and the limit mode is activated following the methods 200 and 300 respectively, compared with the actual vehicle speed AVᵥₑₕ, and with the vehicle speed V_{no lim} when no limit mode is activated (as in the prior art).

Dash-dot line AVᵥₑₕ represents an evolution of the actual vehicle speed over time t, before (t=0 to t=t₁), during (t=t₁ to t=t₃), and after (t=t₃ onwards) going over the obstacle. Solid line Vᵥₑₕ represents an evolution over time of the vehicle speed Vᵥₑₕ as computed from the wheel speed V_{wheel} provided by the speed sensor 114, before, during, and after going over the obstacle when the limit mode is activated while all wheels are off the ground. Dotted line V_{no lim} represents an evolution of the vehicle speed V_{no lim} as computed from the wheel speed V_{wheel}, before, during, and after going over the obstacle, assuming no limit mode is activated while all wheels are off the ground (such as in the prior art).

Turning now more particularly to FIG. 9, the evolution of the vehicle speed Vᵥₑₕ before, during and after the obstacle following the method 200 will be described in comparison with the evolution of the vehicle speed V_{no lim} when no limit mode is available.

From time 0 to t₁, the ATV 10 is operated in the normal operation mode (corresponds to step 204). The vehicle speed Vᵥₑₕ is the actual vehicle speed AVᵥₑₕ (i.e. assuming no slip). The driver actively controls the engine 29.

At t₁, the ATV 10 has lost contact with the ground 1 as the ATV 10 goes over the obstacle. Based on information received by the suspension sensors 104, the ECU 102 determines that all wheels 14 are not in contact in the ground 1 (corresponds to step 208), and the ATV 10 starts to operate in the limit mode (step 210).

As can be seen from t₁ to t₃, the actual vehicle speed AVᵥₑₕ decreases, and the vehicle speed V_{no lim}, should the ATV 10 have continued to operate in the normal mode, increases greatly due to the loss of traction of the driving wheels 11b. The ECU 102 reduces the wheel acceleration a_{wheel}. Because the wheel acceleration a_{wheel} is reduced, the wheel speed V_{wheel} has a limited increase, and therefore the vehicle speed Vᵥₑₕ which is based on wheel speed V_{wheel} increases only by a small amount between t₁ and t₃. Comparatively, the vehicle speed V_{no lim} continues to increase, to eventually reach a value such that a difference d₂ between the actual vehicle speed AVᵥₑₕ and the vehicle speed V_{no lim} is above a difference d_{dam} that could cause damages to the drivetrain 20 upon landing of the ATV 10. When the ATV 10 is operated in the limit mode, the vehicle speed Vᵥₑₕ increases only moderately to reach a difference d₁ between the actual vehicle speed AVᵥₑₕ and the vehicle speed Vᵥₑₕ that is below the difference d_{dam}, thereby avoiding damages to the drivetrain 20 upon landing of the ATV 10.

It is contemplated that the actuation of the limit mode could be done at a time t₄ intermediate to t₁ and t₃ (predetermined time or real-time calculated time by the ECU 102).

At t₃, the ATV 10 lands back on the ground 1, thus forcing the ATV 10 to exit from the limit mode (corresponds to step 212). It is contemplated that interruption events (described above) other than landing on the ground 1 could force the ATV 10 to exit the limit mode at t₃ or sooner. The vehicle speed Vᵥₑₕ recovers the actual vehicle speed AVᵥₑₕ at time t₅ before vehicle speed V_{no lim}, which recovers the actual vehicle speed Vᵥₑₕ at time t₆ later than t₅. Because the drivetrain 20 components are undergoing less stress and for a shorter period of time when using the method 200, the drivetrain 20 is preserved.

Turning now more particularly to FIG. 10, the evolution of the vehicle speed Vᵥₑₕ before, during and after the obstacle following the method 300 will be described in comparison with the evolution of the vehicle speed V_{no lim} when no limit mode is activated, while going over the obstacle.

From time 0 to t₁, the ATV 10 is operated in the normal operation mode (corresponds to step 304). The vehicle speed Vᵥₑₕ equals the actual vehicle speed AVᵥₑₕ (assuming no slip). The ECU 102 determines that the vehicle speed Vᵥₑₕ is greater than the predetermined vehicle speed V_{pred} (corresponds to step 308).

At t₁, the driving wheels 11b accelerate and the vehicle speed Vᵥₑₕ computed from the wheel speed V_{wheel} increases. This situation corresponds to the ATV 10 having the driving wheels 11b not in contact with the ground 1. The ECU 102 monitors the evolution of the vehicle speed Vᵥₑₕ and the wheel acceleration a wheel based on information received from the speed sensor 114.

From t₁ to t₂, the wheel speed V_{wheel} and the wheel acceleration a wheel continue to increase (and hence the vehicle speed Vveh), while the actual vehicle speed AVᵥₑₕ decreases. The ECU 102 determines whether the wheel acceleration a_{wheel} is above the first predetermined wheel acceleration a_{pred} for which it is desired to control the wheel speed V_{wheel} to prevent damage to the drivetrain 20 upon landing of the ATV 10 (corresponds to step 308).

At time t₂, the wheel acceleration a_{wheel} has reached the first predetermined wheel acceleration a_{pred} (corresponds to step 310), and the ATV 10 is operated in the limit mode (corresponds to step 312). It is contemplated that the actuation of the limit mode could be done at a time t₄ intermediate to t₂ and t₃ such that the limit mode would be actuated when the wheel acceleration a_{wheel} is above the first predetermined wheel acceleration a_{pred} for a period of time t₄-t₂. The period of time t₄-t₂ would be predetermined and controlled by the ECU 102. It is also contemplated that t₂ could be a fixed time that would be predetermined or computed in real-time by the ECU 102, from which the value of the first predetermined wheel acceleration a_{pred} could be determined.

From t₂, the ECU 102 controls the engine 29 to reduce the wheel acceleration a wheel. As described above with respect to FIG. 8, reducing the wheel acceleration a_{wheel} limits the wheel speed V_{wheel} and forces the vehicle speed Vᵥₑₕ to increase only in a small amount between t₂ and t₃, compared to the increase in speed of ATV 10 not operated in the limit mode V_{no lim} between t₂ and t₃.

At t₃, the ATV 10 exits the limit mode (corresponds to step 310), and the vehicle speed Vᵥₑₕ recovers the actual vehicle speed AVᵥₑₕ. The interruption event corresponds to the ATV 10 having landed back on the ground 1. It is contemplated that the other interruption events described above with respect to the method 300 could occur at t₃. The driving wheels 11b recover the actual vehicle speed AVᵥₑₕ at time t₅ before the vehicle speed V_{no lim} recovers the actual vehicle speed Vᵥₑₕ at time t₆. Because the drivetrain 20 components are undergoing less stress and for a shorter period of time when using the method 300, the drivetrain 20 is preserved.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A method for controlling a vehicle having wheels, the wheels including at least one driving wheel, the method comprising:
operating the vehicle in a normal operation mode; and
operating the vehicle in a limit mode when a speed of the vehicle is above a first vehicle speed and an acceleration of the at least one driving wheel is above a first wheel acceleration, wherein operating the vehicle in the limit mode includes controlling an engine of the vehicle to at least reduce the acceleration of the at least one driving wheel.

2. The method for controlling a vehicle of claim 1, wherein in the normal operation mode at least one of the one driving wheel is in contact with a ground on which the vehicle operates, and in the limit mode all the wheels are not in contact with the ground.

3. The method for controlling a vehicle of claim 1, wherein the vehicle is operated in the limit mode when the acceleration of the at least one driving wheel is above the first wheel acceleration for a first period of time.

4. The method for controlling a vehicle of claim 3, wherein the vehicle is operated in the limit mode when the speed of the vehicle is above the first vehicle speed for a second period of time.

5. The method for controlling a vehicle of claim 1, further comprising returning to operating the vehicle in the normal operation mode when an interruption event occurs during the operation of the vehicle in the limit mode, the interruption event being at least one of:
the acceleration of the at least one driving wheel being at or below a second wheel acceleration,
a speed of the at least one driving wheel being at or below a first wheel speed,
a speed of the engine being at or below a first engine speed,
brakes of the vehicle being applied,
a position of a throttle lever of the vehicle being changed, and
a control time having elapsed.

6. The method for controlling a vehicle of claim 5, wherein the control time is between 0 and 100 ms.

7. The method for controlling a vehicle of claim 5, wherein the second wheel acceleration is smaller than the first wheel acceleration.

8. The method for controlling a vehicle of claim 7, wherein the second wheel acceleration is about zero.

9. The method for controlling a vehicle of claim 1, further comprising sensing a temperature of an environment, and wherein the vehicle is operated in the limit mode only when the temperature of the environment is above a predetermined temperature.

10. The method for controlling a vehicle of claim 1, wherein the first wheel acceleration is a function of the speed of the vehicle.

11. The method for controlling a vehicle of claim 1, wherein the first wheel acceleration is greater than a maximum acceleration of the at least one driving wheel when the at least one driving wheel is in contact with a ground on which the vehicle operates.

12. The method for controlling a vehicle of claim 1, wherein operating the vehicle in the limit mode includes controlling the engine to eliminate the acceleration of the at least one driving wheel.

13. The method for controlling a vehicle of claim 1, wherein controlling the engine to at least reduce the acceleration of the at least one driving wheel includes at least one of:
reducing an ignition timing of the engine,
reducing an amount of fuel delivered to the engine, and
reducing an amount of air flow delivered to the engine.

14. A method for controlling a vehicle having wheels, the wheels including at least one driving wheel, the method comprising:
operating the vehicle in a normal operation mode; and
operating the vehicle in a limit mode when all the wheels are not in contact with the ground on which the vehicle operates, wherein in the limit mode a rotation of the at least one driving wheel is controlled without active input of a driver of the vehicle.

15. The method for controlling a vehicle of claim 14, wherein the vehicle is operated in the limit mode when all the wheels are not in contact with the ground for a period of time.

16. The method for controlling a vehicle of claim 14, further comprising determining via a sensor linked to a suspension system of the vehicle that all the wheels of the vehicle are not contact with the ground.

17. The method for controlling a vehicle of claim 14, wherein the rotation of the at least one driving wheel is controlled by an Electronic Control Unit.

18. The method for controlling a vehicle of claim 14, wherein operating the vehicle in the limit mode includes at least reducing a difference between a speed of the vehicle based on a rotational speed of the at least one driving wheel and an actual speed of the vehicle.

19. The method for controlling a vehicle of claim 18, wherein at least reducing the difference between the speed of the vehicle based on a rotational speed of the at least one driving wheel and the actual speed of the vehicle includes at least reducing an acceleration of the at least one driving wheel.

20. The method for controlling a vehicle of claim 18, wherein at least reducing the difference between the speed of the vehicle based on a rotational speed of the at least one driving wheel and the actual speed of the vehicle includes controlling an engine torque output of an engine of the vehicle.
